(19) United States
(12) Patent Application Publication
(10) Pub. No.: US 2013/0287203 A1
(43) Pub. Date: Oct. 31, 2013

(54) Reduction of Loudspeaker Distortion for Improved Acoustic Echo Cancellation

(71) Applicant: Richard Hodges, Oakland, CA (US)

(72) Inventor: Richard Hodges, Oakland, CA (US)

(73) Assignee: PLANTRONICS, INC., Santa Cruz, CA (US)

(21) Appl. No.: 13/458,122

(22) Filed: Apr. 27, 2012

(51) Int. Cl. H04M 9/08

(52) U.S. Cl. 379/406.01

(57) ABSTRACT

Methods and apparatuses for improved echo cancellation are disclosed. In one example, an audio signal to be output at a loudspeaker is received and processed to generate an optimized audio signal. The optimized audio signal produces a reduced distortion when output at the loudspeaker. The method further includes utilizing the optimized audio signal to reduce echo in a transmit audio signal.

### BACKGROUND OF THE INVENTION

During a telephone conversation performed over a speakerphone, headset, or other telecommunication device, the sound output from the speaker (also referred to herein as a loudspeaker) may undesirably feed back to the device microphone. The speaker output becomes mixed with the device user's voice which is captured by the device microphone.

The presence of the loudspeaker sound output in the microphone output reduces the quality of the signal to the person on the other end of the conversation (referred to herein as the far end user or far end call participant). The captured loudspeaker sound output manifests itself as an undesirable echo that is heard by the far-end user, and may lead to loop instability.

In the prior art, various acoustic echo reduction techniques have been attempted. These techniques have included 1) gating, where the transmit (Tx) signal gain is reduced when the local user is not talking, 2) center clipping, where the parts of the Tx signal near zero are removed, and (3) echo cancellation (EC) in which a linear adaptive filter (AF) is used to remove much of the echo.

However, these processing techniques often provide limited success in eliminating the acoustic echo. Other solutions attempting to address acoustic echo have drawbacks as well. The use of higher quality loudspeakers may be too expensive, or add too much weight. If the volume of the speaker output is reduced, the user will often desire more volume, especially on receive signal peaks, than is consistent with low distortion. Another prior solution is to follow the echo cancellation by center clipping and/or gating applied to the transmit signal. However, this may introduce undesirable artifacts.

As a result, improved methods and apparatuses for improved echo cancellation are needed.

### BRIEF DESCRIPTION OF THE DRAWINGS

The present invention will be readily understood by the following detailed description in conjunction with the accompanying drawings, wherein like reference numerals designate like structural elements.

FIG. 1 illustrates an echo control system in one example.

FIG. 2 illustrates a simplified block diagram of the speaker distortion reducer shown in FIG. 1 in one example.

FIG. 3 illustrates a simplified block diagram of the speaker distortion reducer shown in FIG. 1 in a further example.

FIG. 4 illustrates a method for echo control in one example.

FIG. 5 illustrates a method for echo control in a further example.

FIG. 6 illustrates a method for echo control in a further example.

FIG. 7 illustrates an audio device in one example.

### DESCRIPTION OF SPECIFIC EMBODIMENTS

Methods and apparatuses for improved echo cancellation are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

Acoustic Echo Cancellation (AEC) is the most desirable of the three techniques described above because it permits full-duplex communication, whereby both the near end and far end user can speak at the same time. But a major limitation in AEC is that only components of the echo signal that are linearly related to the Rx signal (received audio signal) can be cancelled. If nonlinear distortion is introduced by electronics, digital processing, or behavior of the loudspeaker, the nonlinear components cannot be cancelled and will cause audible distorted echo. The predominant source of nonlinear distortion is the loudspeaker. Higher-quality loudspeakers generate less distortion, but may be too expensive, or add too much weight.

The inventor has recognized that speaker distortion limits the effectiveness of echo cancellation techniques because the reference signal that is used to adapt the adaptive filter (AF) in the echo canceller is not a true representation of the acoustic signal generated by the speaker. As a result, the non-linear part of the echo cannot be cancelled. In one example, signal processing method(s) for controlling loudspeaker distortion are described. In one example, the generation of distortion by the speaker is modeled and the speaker drive signal is modified to maintain a low-distortion regime. There are several causes of speaker distortion, including: 1) cone breakup, 2) excitation of cone rocking mode, 3) doppler distortion, where the cone velocity becomes an appreciable fraction of the speed of sound, and 4) cone excursion (CE) exceeding the linear range of the surround compliance and/or motor magnetic circuit. In well designed speakers, CE is the dominant cause, however all four causes become important only when the CE, cone velocity, and/or the motor drive force exceeds fixed thresholds. Several related techniques for mitigating CE distortion are described herein, with the understanding that modified versions of these techniques can if necessary address other distortion modes.

If there were no nonlinear limits to CE, then the instantaneous magnitude of CE could be modeled as a linear response to the motor drive signal. This model accounts for mechanical factors such as moving mass, surround compliance, and acoustic impedance, and electrical effects such as drive and wiring impedance, back emf generation by cone motor, and voice coil inductance. All of these factors can be subsumed into a low-order linear filter; in most cases a two-pole two-zero digital filter can be developed that will provide a very good approximation to the true cone excursion; however it is possible to user somewhat higher order filters if necessary.

In a first example approach, a symmetrical hard or soft limiter function is applied to the modeled CE signal which limits it to values below the distortion threshold. The inverse CE model is then applied to this signal. The resulting signal will then be used as the motor drive signal. If the model is accurate enough, taking into account variations such as component variations, thermal effects, manufacturing tolerances, etc., the resulting CE will not exceed the threshold for distortion. The new drive signal can it is true contain distortion components compared to the original Rx signal, but these components will be no worse than if the CE nonlinearity itself had caused them, and within reasonable limits these do not greatly affect the subjective quality or intelligibility of Rx audio. The advantage for EC is that the new drive signal will be a much better reference signal for the AF because the audio signal generated by the cone will not be distorted in relation to it.

For computational efficiency it may be desirable to split the frequencies of the Rx signal into a high band and a low band; only the low band is processed as described above, because it is only low frequencies that normally are capable of generating large enough CE to cause distortion. The processed low band signal is then recombined with the high band signal (to which a compensating delay has been applied) to generate the actual motor drive signal.

In a second example approach, an outer feedback loop is used to measure the recent maximum (or other measure such as recent RMS) of the CE or only of its low-band components. When this value approaches a threshold, a gain-reduction is applied to the Rx signal to keep the maximum measure within the threshold by inverse feedback. This gain reduction factor can be slowly-varying, possibly with different attack and release time constants, which will reduce the generation of distortion components by the algorithm itself. In one example, this second approach is combined with the first approach so that rapid increases in Rx signal amplitude can still be kept below the CE distortion threshold.

In a third example approach, a high-accuracy model of the CE as a function of motor drive signal is used. In one example, this is an instantaneous model of the CE allowing the determination of the CE at any given instant. This model is utilized to 1) generate an accurate representation of the actual CE and hence of the acoustic signal; 2) be used in an instantaneous feedback loop to linearize the CE. Linearization can only be done within limits, and if these limits are threatened to be exceeded, the previously described two approaches can eliminate any nonlinearity between the AF reference and the acoustic signal.

In a fourth example approach, the instantaneous CE at the speaker is actually measured while in use by a user instead of utilizing a model generated at the manufacturer. This is done in a number of different ways, for example: capacitive sensing; optical sensing; accelerometer attached to cone, or a sense coil attached to the cone. The measured CE is used directly as the adaptive filter reference in the acoustic echo canceller (AEC). The measured CE may also be used in a feedback loop similarly as in the second and third approaches above, in order to reduce or eliminate generation of nonlinear distortion.

Advantageously, the methods and systems described offer a better tradeoff between maximum Rx loudness and echo artifacts generated by non-cancelled Rx audio. In addition, the methods and systems do so at a low cost compared to other echo mitigation techniques.

In one example, a method for echo control includes receiving an audio signal to be output at a loudspeaker and processing the audio signal to generate an optimized audio signal. The optimized audio signal produces a reduced distortion when output at the loudspeaker. The method further includes utilizing the optimized audio signal to reduce echo in a transmit audio signal to be transmitted to a far-end listener.

In one example, a method for echo control includes applying a filter modeling a loudspeaker cone excursion response to a receive audio signal to generate a filtered audio signal. A limiter function is applied to the filtered audio signal to generate a limited signal. An inverse of the filter modeling the loudspeaker cone excursion is applied to the limited signal to generate an optimized receive audio signal. The optimized receive audio signal is output to an echo controller and a loudspeaker driver.

In one example, an audio device includes a microphone, a speaker, and a network interface operable to receive a receive audio signal to be output at the speaker and transmit a transmit signal to a call participant. The audio device includes a processor configured to process the receive audio signal to generate an optimized receive audio signal, the optimized receive audio signal producing a reduced speaker distortion, wherein the processor is further configured to reduce echo in the transmit signal utilizing the optimized receive signal.

In one example, a method for echo control includes receiving an audio signal to be output at a loudspeaker and processing the audio signal to generate a lower frequency band component signal and a higher frequency band component signal. The lower frequency band component is processed to generate an optimized lower frequency band component signal. The optimized lower frequency band component is combined with the higher frequency band component signal to generate an optimized audio signal producing a reduced distortion when output at the loudspeaker. The optimized audio signal is utilized to reduce echo in a transmit audio signal to be transmitted to a far-end listener.

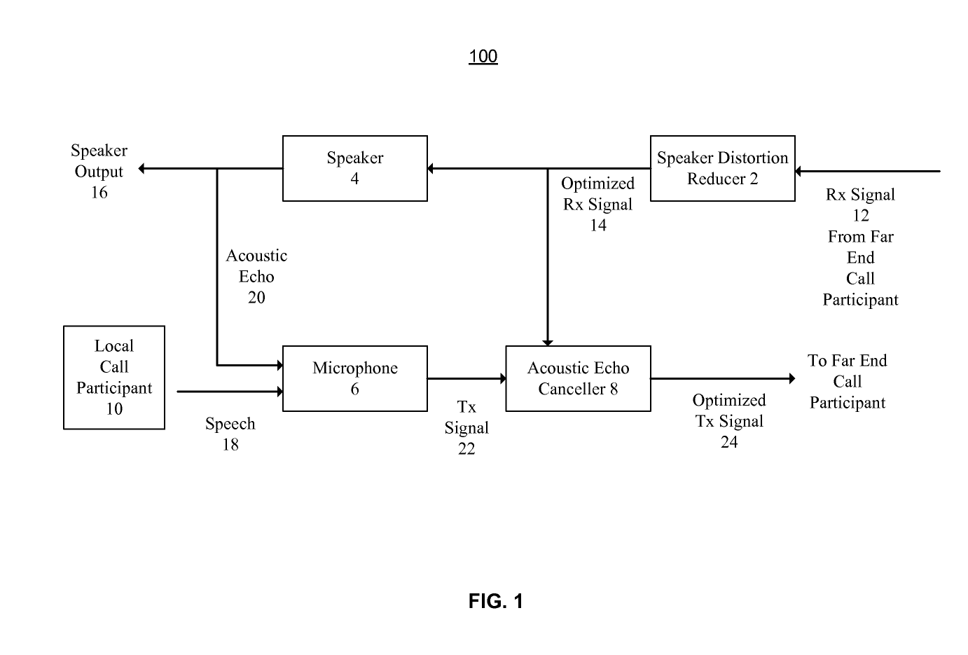

FIG. 1 illustrates an echo control system 100 in one example. Echo control system 100 includes a speaker distortion reducer 2 and acoustic echo canceller 8. The speaker distortion reducer 2 receives a receive (Rx) signal 12 from a far end call participant and processes the Rx signal 12 to generate an optimized Rx signal 14. Optimized Rx signal 14 produces a reduced distortion when output at a speaker 4 relative to a Rx signal 12 not optimized by speaker distortion reducer 2. In one example, the reduced distortion is a reduced cone excursion distortion.

Optimized Rx signal 14 is input to speaker 4, which outputs a speaker output 16. In addition to being heard by local call participant 10, speaker output 16 will disperse through the air and be detected by a microphone 6 as a resulting acoustic echo 20. Microphone 6 also captures speech 18 from a local call participant 10. Microphone 6 outputs a transmit (Tx) signal 22 including speech 18 components and acoustic echo 20 components.

Optimized Rx signal 14 is input to acoustic echo canceller 8 to reduce echo in the transmit signal 22 to be transmitted to a far-end listener. Acoustic echo canceller 8 receives Tx signal 22 and optimized Rx signal 14. In one example, acoustic echo canceller 8 is a linear adaptive filter which removes the acoustic echo 20 component from Tx signal 22 utilizing optimized Rx signal 14 using echo cancellation processing. The output of acoustic echo canceller 8 is an optimized Tx signal 24 having acoustic echo 20 removed. Optimized Tx signal 24 is sent to a far end call participant.

Echo control system 100 can be incorporated into various electronic devices to provide improved echo reduction. For example such electronic devices may include speakerphones, headsets, mobile phones, and video conferencing systems. The speaker distortion reducer 2 can be implemented in hardware, in software, or in any combination thereof.

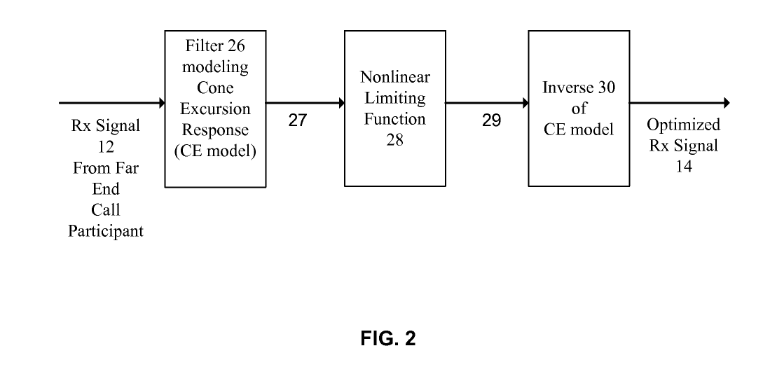

FIG. 2 illustrates a simplified block diagram of the speaker distortion reducer 2 shown in FIG. 1 in one example. In the example shown in FIG. 2, speaker distortion reducer 2 includes a filter 26 modeling a loudspeaker cone excursion response (i.e., a cone excursion model (CE)) to a receive audio signal, a nonlinear limiting function 28, and an inverse 30 of the cone excursion model.

Filter 26 is applied to Rx signal 12 to generate a filtered audio signal 27. In one example, filter 26 is an IIR filter. In one example, filter 26 is a low-order linear filter. In one example, filter 26 is a two-pole, two-zero digital filter. In one example, the CE model is obtained utilizing a laboratory measurement. In the laboratory, a laser measurement system, or other means, is used to measure the actual excursion of the loudspeaker cone in response to a known input drive signal. By standard techniques of system identification, a model is determined that represents the response, within its linear range, of the loudspeaker to an arbitrary input. The system transformation response is approximated as closely as possible by a low-order IIR filter. The inverse 30 the filter 26 is obtained by simply reversing the roles of the numerator and denominator of the IIR filter definition. In a further example, a mathematical model of the CE is created which takes into account known electrical, magnetic, and acoustic phenomena.

Filtered audio signal 27 is input to non-linear limiting function 28 to generate a limited signal 29. In one example, the limiting function 28 is a clipper function. In one example, the limiting function 28 is configured to limit the filtered audio signal to a level below a cone excursion distortion threshold.

In one example, the limiting function 28 is a clipper function:

F(x)=if x>=Limit then Limit

else if −Limit≦x≦Limit then x

else if x<−Limit then−Limit

where
x is the input, the modeled cone excursion (CE)
Limit is the maximum value of CE before unacceptable distortion occurs
F(x) is the output of the limiter

In a further example, the limiting function 28 is a “soft limit” function, such as:

F(x)=a tan(x)*Limit/(pi/2)

where
a tan is the inverse tangent function
pi is the number 3.1415926 . . .

An inverse 30 of the filter 26 modeling the loudspeaker cone excursion is applied to the limited signal to generate optimized receive signal 14. The optimized receive signal 14 is output to an echo controller and a loudspeaker driver as shown in FIG. 1. In one example, a gain reduction is applied to Rx signal 12 if a measured cone excursion exceeds a threshold value.

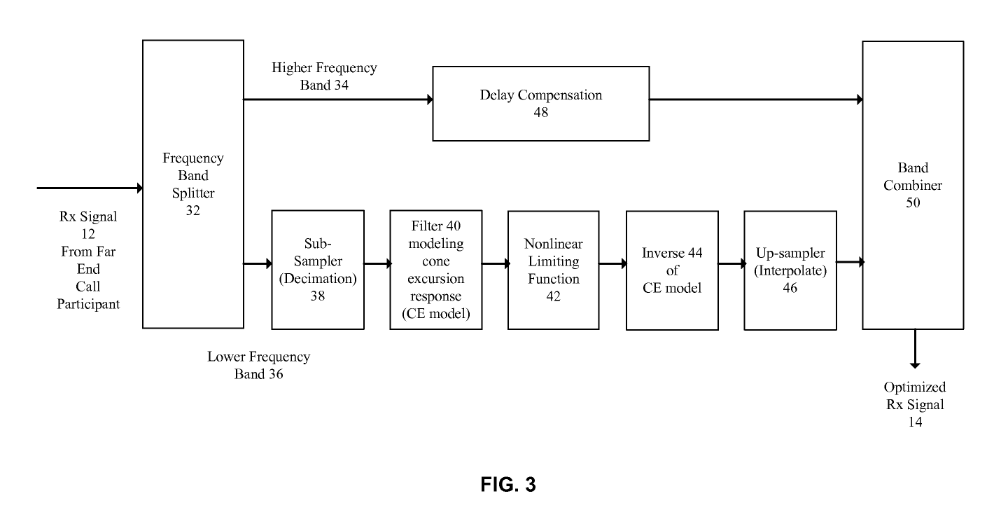

FIG. 3 illustrates a simplified block diagram of the speaker distortion reducer 2 shown in FIG. 1 in a further example. In the example shown in FIG. 3, speaker distortion reducer 2 includes a frequency band splitter 32, sub-sampler 38 (decimation), filter 40 modeling a loudspeaker cone excursion response (i.e., a cone excursion model (CE) to a receive audio signal, a nonlinear limiting function 42, an inverse 44 of the cone excursion model, up-sample (interpolation) function 46.

Frequency band splitter 32 processes the Rx signal 12 to generate a lower frequency band component signal 36 and a higher frequency band component signal 34. In one example, the frequency band splitter 32 is a pair of digital filters that separates the frequencies of its input signal into “low” frequencies, those below some cutoff frequency, and “high” frequencies.

The lower frequency band component signal 36 is processed to generate an optimized lower frequency band component signal. The low frequency band component signal 36 is sub-sampled or decimated by sub-sampler 38 by a factor to reduce the amount of computation required to calculate the anti-distortion function. Decimation reduces the number of samples in data. For example if the original signal is digitized at 16000 samples per second, giving a bandwidth of 8000 Hz, but it is desired only to process the lowest 2000 Hz of the signal, the following is performed: 1) pass the signal through a sharp low-pass filter with a cutoff frequency slightly below 2000 Hz, and 2) remove 3 out of each 4 samples, resulting in a sample rate of 4000 samples per second. The low pass filter is essential to reduce “abasing” to a level where it doesn't cause problems. In one example, the band-splitting filter also serves as the anti-aliasing low-pass filter.

Similar to the process described in FIG. 2, the output of the sub-sampler 38 is processed to generate an optimized lower frequency band component signal by applying a filter 40 modeling a loudspeaker cone excursion response, applying a limiting function 42, and applying an inverse 44 of the filter modeling the loudspeaker cone excursion. The output of inverse 44 is up-sampled or interpolated to restore it to the original sample rate before re-combining with the high frequency band component signal 34. In the illustrative example discussed above, interpolation raises the sample rate back to the original 16000 s/s. For example, the interpolation includes: 1) insert, in the example given, three zero samples between every sample of the 2000 s/s signal, and 2) apply a sharp low-pass filter to eliminate aliasing.

Delay compensation 48 is applied to high frequency band component signal 34 prior to combination with lower frequency band component signal 36 to compensate for the delay in the low-frequency band component signal 36 due to the decimation, filtering, inverse filtering, and interpolation. The optimized lower frequency band component is combined with the higher frequency band component signal at frequency band combiner 50 to generate the optimized Rx signal 14.

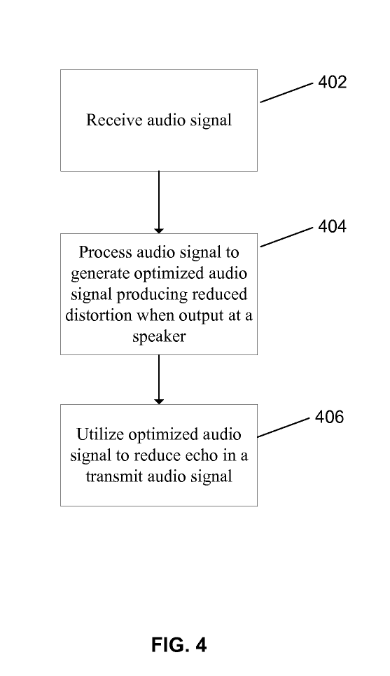

FIG. 4 illustrates a method for echo control in one example. At block 402, an audio signal to be output at a speaker is received. At block 404, the audio signal is processed to generate an optimized audio signal, the optimized audio signal producing a reduced distortion when output at the speaker. In one example, processing the audio signal to generate an optimized audio signal includes applying a filter modeling a loudspeaker cone excursion response, applying a limiter function, and applying an inverse of the filter modeling the loudspeaker cone excursion. In one example, the limiter function is a clipper function. In one example, the filter is an IIR filter. In one example, the reduced distortion is a reduced cone excursion distortion. At block 406, the optimized audio signal is utilized to reduce echo in a transmit audio signal to be transmitted to a far-end listener.

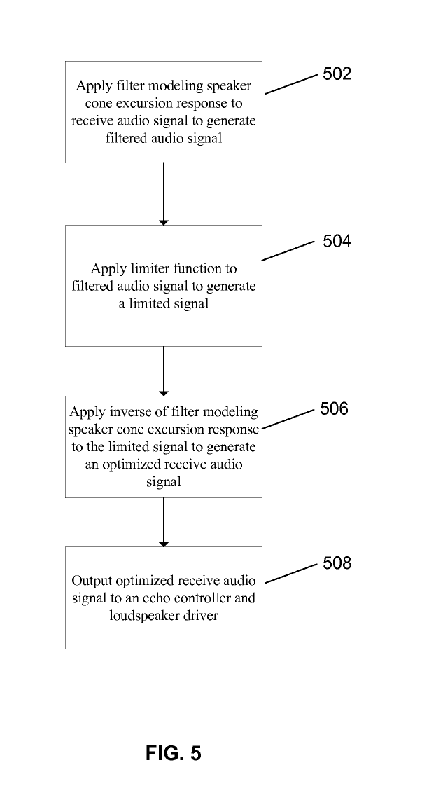

FIG. 5 illustrates a method for echo control in a further example. At block 502 a filter modeling a loudspeaker cone excursion response is applied to a receive audio signal to generate a filtered audio signal. For example, the filter is an IIR filter, a low-order linear filter, or a two-pole, two-zero digital filter.

At block 504 a limiter function is applied to the filtered audio signal to generate a limited signal. In one example, the limiter function is a clipper function. In one example, the limiter function is configured to limit the filtered audio signal to a level below a cone excursion distortion threshold.

At block 506, an inverse of the filter modeling the loudspeaker cone excursion is applied to the limited signal to generate an optimized receive audio signal. At block 508, the optimized receive audio signal is output to an echo controller and a loudspeaker driver. In one example, the method further includes applying a gain reduction to the receive audio signal if a measured cone excursion exceeds a threshold value.

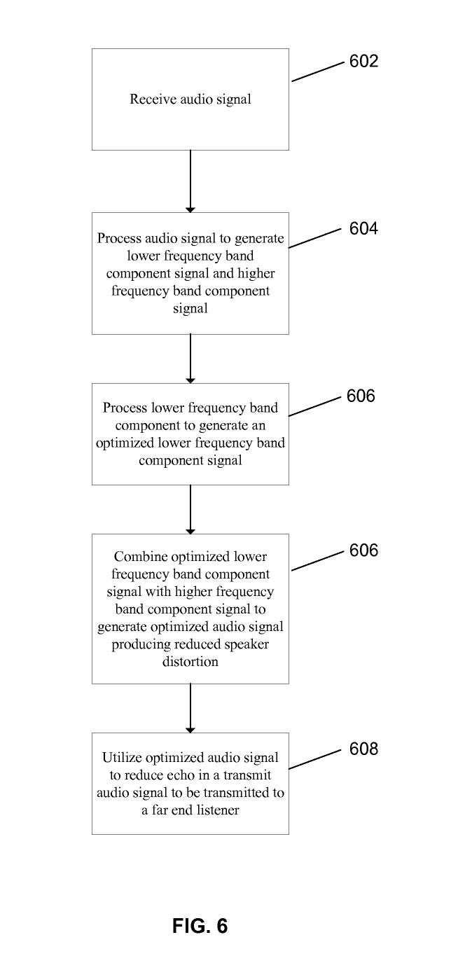

FIG. 6 illustrates a method for echo control in a further example. At block 602 an audio signal to be output at a loudspeaker is received. At block 604 the audio signal is processed to generate a lower frequency band component signal and a higher frequency band component signal.

At block 606 the lower frequency band component is processed to generate an optimized lower frequency band component signal. In one example, processing the lower frequency band component signal to generate an optimized lower frequency band component signal comprises applying a filter modeling a loudspeaker cone excursion response, applying a limiter function, and applying an inverse of the filter modeling the loudspeaker cone excursion.

At block 608 the optimized lower frequency band component is combined with the higher frequency band component signal to generate an optimized audio signal producing a reduced distortion when output at the loudspeaker. At block 610 the optimized audio signal is utilized to reduce echo in a transmit audio signal to be transmitted to a far-end listener.

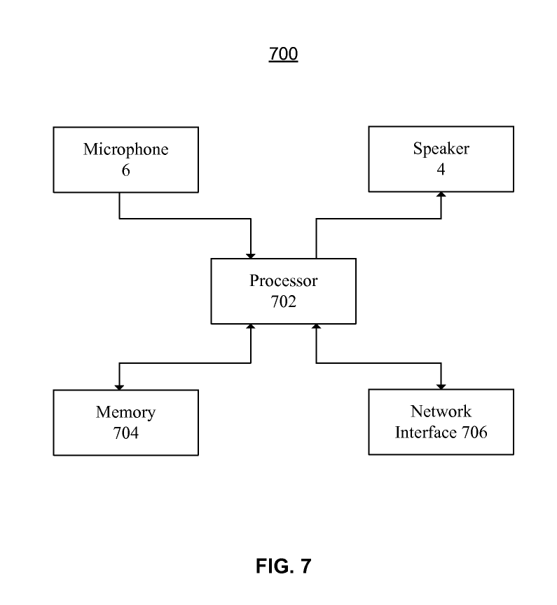

FIG. 7 illustrates an audio device 700 in one example configured to implement one or more of the examples described herein. Examples of audio device 700 include mobile phones, headsets, desktop phones, and personal computers. In one example, an audio device 700 includes a microphone 6, a speaker 4, a memory 704, and a network interface 706 operable to receive a receive audio signal to be output at the speaker and transmit a transmit audio signal to a call participant. Audio device 700 includes a digital-to-analog converter (D/A) coupled to a speaker 4 and an analog-to-digital converter (A/D) coupled to microphone 6.

In one example, the network interface 706 is a wireless transceiver or a wired network interface. In one example, the microphone 6 and the speaker 4 are configured to operate as a speakerphone. In one example, the receive audio signal is processed by applying a filter modeling a speaker cone excursion response, applying a limiter function, and applying an inverse of the filter modeling the speaker cone excursion.

Memory 704 represents an article that is computer readable. For example, memory 704 may be any one or more of the following: a hard disk, a floppy disk, random access memory (RAM), read only memory (ROM), flash memory, CDROM, or any other type of article that includes a medium readable by processor 702. Memory 704 can store computer readable instructions for performing the execution of the various method embodiments of the present invention. Computer readable instructions may be loaded in memory 704 for execution by processor 702. In one example, processor 702 implements a speakerphone operation that allows hands-free operation and one or more users to talk on the phone at once.

Network interface 706 allows device 700 to communicate with other devices. Network interface 706 may include a wired connection or a wireless connection. Network interface 706 may include, but is not limited to, a wireless transceiver, a modem, a Network Interface Card (NIC), an integrated network interface, a radio frequency transmitter/receiver, a USB connection, or other interfaces for connecting computing device 700 to a telecommunications network such as a cellular network, the PSTN, or an IP network.

In one example, the audio device 700 includes a processor 702 configured to process the receive audio signal to generate an optimized receive audio signal, the optimized receive audio signal producing a reduced speaker distortion, wherein the processor 702 is further configured to reduce echo in the transmit signal utilizing the optimized receive signal. In one example, the audio device 700 further includes a sensor configured to measure a cone excursion of the speaker, the cone excursion processed to generate the optimized receive audio signal. For example, the sensor is a capacitive sensor, an optical sensor, or an accelerometer.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1. A method for echo control comprising:
applying a filter modeling a loudspeaker cone excursion response to a receive audio signal to generate a filtered audio signal;
applying a limiter function to the filtered audio signal to generate a limited signal;
applying an inverse of the filter modeling the loudspeaker cone excursion response to the limited signal to generate an optimized receive audio signal; and
outputting the optimized receive audio signal to an echo controller and a loudspeaker driver.

2. The method of claim 1, wherein the filter is an IIR filter.

3. The method of claim 1, wherein the filter is a low-order linear filter.

4. The method of claim 1, wherein the filter is a two-pole, two-zero digital filter.

5. The method of claim 1, wherein the limiter function is a clipper function.

6. The method of claim 1, wherein the limiter function is configured to limit the filtered audio signal to a level below a cone excursion distortion threshold.

7. The method of claim 1, further comprising:
applying a gain reduction to the receive audio signal if a measured cone excursion exceeds a threshold value.

8. A method for echo control comprising:
receiving an audio signal to be output at a loudspeaker;
processing the audio signal to generate an optimized audio signal, the optimized audio signal producing a reduced distortion when output at the loudspeaker; and
utilizing the optimized audio signal to reduce echo in a transmit audio signal to be transmitted to a far-end listener.

9. The method of claim 8, wherein the reduced distortion is a reduced cone excursion distortion.

10. The method of claim 8, wherein processing the audio signal to generate an optimized audio signal comprises applying a filter modeling a loudspeaker cone excursion response, applying a limiter function, and applying an inverse of the filter modeling the loudspeaker cone excursion response.

11. The method of claim 10, wherein the limiter function is a clipper function.

12. The method of claim 10, wherein the filter comprises an IIR filter.

13. An audio device comprising:
a microphone;
a speaker;
a network interface operable to receive a receive audio signal to be output at the speaker and transmit a transmit signal to a call participant; and
a processor configured to process the receive audio signal to generate an optimized receive audio signal, the optimized receive audio signal producing a reduced speaker distortion, wherein the processor is further configured to reduce echo in the transmit signal utilizing the optimized receive audio signal.

14. The audio device of claim 13, wherein the network interface is a wireless transceiver or a wired network interface.

15. The audio device of claim 13, wherein the microphone and the speaker are configured to operate as a speakerphone.

16. The audio device of claim 13, further comprising a sensor configured to measure a cone excursion of the speaker, the cone excursion processed to generate the optimized receive audio signal.

17. The audio device of claim 16, wherein the sensor comprises a capacitive sensor, an optical sensor, or an accelerometer.

18. The audio device of claim 13, wherein the receive audio signal is processed by applying a filter modeling a speaker cone excursion response, applying a limiter function, and applying an inverse of the filter modeling the speaker cone excursion.

19. A method for echo control comprising:
receiving an audio signal to be output at a loudspeaker;
processing the audio signal to generate a lower frequency band component signal and a higher frequency band component signal;
processing the lower frequency band component signal to generate an optimized lower frequency band component signal; and
combining the optimized lower frequency band component signal with the higher frequency band component signal to generate an optimized audio signal producing a reduced distortion when output at the loudspeaker.
utilizing the optimized audio signal to reduce echo in a transmit audio signal to be transmitted to a far-end listener.

20. The method of claim 19, wherein processing the lower frequency band component signal to generate an optimized lower frequency band component signal comprises applying a filter modeling a loudspeaker cone excursion response, applying a limiter function, and applying an inverse of the filter modeling the loudspeaker cone excursion response.
